(19) United States
(12) Patent Application Publication
(10) Pub. No.: US 2024/0268273 A1
(43) Pub. Date: Aug. 15, 2024

(54) AIR DELIVERY SIDE DISCHARGE WINDROWER

(71) Applicant: Loftness Specilized Farm Equipment, Inc., Hector, MN (US)

(72) Inventor: William C. Schafer, Hector, MN (US)

(73) Assignee: Loftness Specilized Farm Equipment, Inc., Hector, MN (US)

(21) Appl. No.: 18/107,922

(22) Filed: Feb. 9, 2023

(51) Int. Cl. A01F 29/12; A01F 29/04

(52) U.S. Cl. CPC A01F 29/12; A01F 29/04; A01F 29/01

(57) ABSTRACT

Lower repair costs and more reliable operation are achieved by eliminating certain moving parts of a windrower and providing the windrower with a wing having a pair of channels which cooperate to redirect to one end of a machine stover entrained in an airflow ejected out the rear of a shredder.

### CROSS-REFERENCED TO RELATED APPLICATIONS

Not applicable

### STATEMENT REGARDING FEDERALLY SPONSORED RESEARCH OR DEVELOPMENT

Not applicable

### BACKGROUND OF THE INVENTION

### I. Field of the Invention

The present invention relates to equipment used to improve the efficiency and profitability of agricultural operations. More specifically, the present invention relates to machines, specifically windrowers, use to collect stover into windrowers for baling.

### II. Discussion of the Prior Art

Stover is the crop residue left in the field after harvesting grain. Stover includes the leaves and stalks of field crops, such as corn, sorghum, and other small grains, that are commonly left in a field after harvesting.

Farmers have found various uses for the stover gathered and removed from fields. Historically, stover has been primarily used for livestock bedding, but in some cases, it can also provide some nutritional value as part of livestock feed rations. More recently, stover has been used as a source of energy. Stover has been used as a source material in ethanol production. Stover may also be burned as a heat source or used directly in other forms of energy production.

Gathering and removing stover from a field typically involves several steps. First, the farmer must cut-off the stover and reduce the particle size of the stover. This step is typically performed using a conventional crop shredder machine, which deposits the processed stover back on the ground. The second step is a raking operation. More specifically, the field is raked to deposit the processed stover into windrows. Third, a baler machine is used to harvest the processed stover as bales.

Today, many farmers perform the first and second steps outlined above in a single pass using a windrower machine. Windrower machines combine the operations of cutting off and reducing the particle size, with the operation of depositing the product into windrows in preparation for subsequent harvest using a baler.

Originally, windrow machines had a center discharge like the Model 180 and 240 Center Discharge Windrowers made by Loftness Specialized Equipment of Hector, Minnesota. As farming operations grew and farmers strived for greater efficiency, “End Discharge” windrowers such as the Loftness Draper Windrowers were developed. The advantage of the “End Discharge” system, is that the product from the entire width of the cutting unit is delivered to one end of the machine. As such, when the farmer makes a full round, (traveling across the field in one direction and then returning back in the opposite direction), the processed stover is deposited into groups of two immediately adjacent (co-mingled) windrows. Each such group of two such windrows may be harvested together by the baler in a single pass. This reduces by half the number passes through a field that the baler must make.

Center discharge windrowers typically used air deflector panels to simply deflect or throw the material to the center. Prior efforts to design “End Discharge” windrowers that would use air deflector panels to deflect to the side of the machine proved unsuccessful. Trying to move all the processed stover to the end of the machine using air alone seemed to be impractical and consistently being able to do so seemed unachievable.

Equipment manufacturers responded by developing machines that incorporated some type of mechanical means to deliver the product to the end. These mechanical delivery means included employing either (i) a screw-type auger extending through a u-shaped trough, (ii) a steel pintle/drag chain with cross-slats, or (iii) as in the Loftness Draper Windrowers, a rubber belt conveyor. While these designs satisfactorily deliver processed stover to to the end of the machines, and made it possible to deposit the processed stover into groups of two immediately adjacent (co-mingled) windrows, these prior art designs have certain disadvantages.

First mechanical designs using auger or drag chain or event belt conveyors have the potential to get clogged or plugged up in various crop conditions. Second, there is the potential for stover to get wrapped around the moving parts, causing added resistance, or possible damage to the machine. Third, maintenance costs in the form of labor and replacement parts, not to mention the costly downtime if the machine breaks down during the busy harvest schedule, make such mechanical designs less than ideal.

A real need, therefore, still exists for a simple and effective way, that overcomes the foregoing disadvantages, to move substantially all the stover processed by a shredder to the end of the machine and to deposit the processed stover into groups of two immediately adjacent (co-mingled) windrows.

### SUMMARY OF THE INVENTION

The present invention provides various improvements related to machines able, in a single pass, to (i) cut-off and reduce the particle size of the stover, and (ii) deposit the processed stover back on the ground into groups of two immediately adjacent (co-mingled) windrows when the farmer makes a full round. i.e., traveling across the field in one direction and then returning back). These improvements reduce maintenance costs and downtime, the risk of clogging, and the amount of and dirt and other foreign materials that ultimately find their way into bales.

More specifically, the present invention relates to a windrower comprises a shredder having a plurality of spinning knives located in a housing having an elongate discharge opening. As the knives spin, they process the stover by chopping it into a fine particulate. The spinning of the knives also creates an airflow such that the air and stover particulate entrained therein, exits the discharge opening. Windrowers made in accordance with the present invention further comprise a wing having a stowed position and a deployed position. A pair of linkages and at least one linear hydraulic actuator are used to move the wing between its stowed position and its deployed position. The wing, when in the wing's deployed position, is adapted to direct the airflow and the entrained stover to one side of the machine where the processed stover is deposited in a row on the ground. In the absence of the wing, the airflow generated by spinning knives would hurl the entrained material through a discharge opening, up into the air, scattering the processed stover behind the machine in a randomized fashion.

Directing substantially all the stover material from the discharge opening to one side of the machine is achieved by attaching the wing behind the discharge opening. The wing extends the full length of discharge opening and has a deposit end and a non-deposit end. When deployed, the wing is angled relative to the housing is such that the non-deposit end of the wing is closer to the housing than the deposit end of the wing.

The wing includes a primary baffle assembly comprising a top plate having a first proximal end and a first distal end, a bottom plate having a second proximal end and a second distal end, and a transition extending between the first distal and second distal end. When the wing is deployed, the first and second proximal ends are positioned closest to the housing such that the top plate, transition, and bottom plate form a first channel open toward the discharge opening of the shredder. The top plate resides above the top of the discharge opening and the second proximal end is below the bottom the discharge opening.

The wing further comprises a secondary baffle assembly positioned within the first channel of the primary baffle assembly. The secondary baffle assembly extends the full length of the primary baffle assembly. The secondary baffle assembly descends from the top plate of the primary baffle assembly and then curves back toward, but is spaced by a gap from, the transition and bottom plate. As so constructed, secondary baffle assembly, together with the primary baffle assembly, form a secondary channel open at the bottom and extending the length of the wing. Both the primary and secondary channels are also open at the deposit end of the wing.

The wing may further comprise a tertiary baffle assembly adjacent to the deposit end openings of the first and second channels. The tertiary baffle assembly may simply be a plate or series of teeth coupled to the wing and banging down adjacent to and spaced from the deposit end openings of the first and second channels.

When a windrower made in accordance with the present invention is used, the wing is deployed. As the knives of the shredder spin, an airflow is created up and out through the discharge opening of the housing into the primary and secondary channels of the wing. The overall angle of the wing and the shapes of the first and second channels serve to redirect virtually all this airflow toward and out the deposit end openings of the first and second channels. More specifically, a first airflow entering the wing from the discharge opening is divided by the primary and secondary baffle assemblies into two distinct second and third airflows. The second airflow is deflected and directed along the first channel to and out the discharge end. The third airflow comprises air entering the secondary channel through the gap. The shape of the secondary baffle causes this air to move in a rotational and longitudinal screw-like fashion through the secondary channel to the discharge end of the wing. As the windrower moves through a field, the knives draw the stover into the housing, chop it into a fine particulate, and entrains the processed stover particulate into the air flows. As such, substantially all the processed stover travels into the first and second channels and then through the first and second channels to and out the openings of the channels at the deposit end of the wing. Material striking the tertiary baffle assembly after exiting the first and second channels at the discharge end of the wing then falls to the ground in an organized row.

### BRIEF DESCRIPTION OF THE DRAWINGS

The foregoing features, objects and advantages of the invention will become apparent to those skilled in the art from the following detailed description of the preferred embodiment, especially when considered in conjunction with the accompanying drawings in which like numerals in the several views refer to corresponding parts:

FIG. 1 is a front view of a windrowing machine made in accordance with the present invention.

FIG. 2 is a back view of the windrowing machine of FIG. 1.

FIG. 3 is a bottom view of the windrowing machine of FIG. 1.

FIG. 4 is a top view of the windrowing machine of FIG. 1.

FIG. 5 is a left side view of the windrowing machine of FIG. 1.

FIG. 6 is a right side view of the windrowing machine of FIG. 1.

FIG. 7 is a right side view of the windrowing machine of FIG. 1 with the tertiary baffle removed.

FIGS. 8 through 18 are a collection of isometric views of the windrowing machine for FIG. 1 from various perspectives with the of the wing in its deployed position.

FIGS. 17 through 20 are a collection of isometric views of the windrowing machine of FIG. 1 with the wing in its stowed position.

FIGS. 21 through 23 illustrate the flow of air, and processed stover entrained in the air, to and across the wing through a secondary channel.

### DESCRIPTION OF THE PREFERRED EMBODIMENT

This description of the preferred embodiments is intended to be read in connection with the accompanying drawings, which are to be considered part of the entire written description of this invention. In the description, relative terms such as “lower”, “upper”, “horizontal”, “vertical”, “above”, “below”, “up”, “down”, “top” and “bottom” as well as derivatives thereof (e.g., “horizontally”, “downwardly”, “upwardly”, etc.) should be construed to refer to the orientation as then described or as shown in the drawings under discussion. These relative terms are for convenience of description and do not require that the apparatus be constructed or operated in a particular orientation. Terms such as “connected”. “connecting”, “attached”, “attaching”, “join” and “joining” are used interchangeably and refer to one structure or surface being secured to another structure or surface or integrally fabricated in one piece, unless expressively described otherwise.

The windrower 1 shown in the drawings has two main assemblies, specifically a shredder 2 and wing 3. The shredder 2 sits on a frame selectively supported by two independent sets of wheels. The first independent set of wheels comprises wheels 12 and 13 which are deployed to permit the windrower 1 to be towed using a first hitch assembly 14. The wheels 12/13 and hitch assembly 14 are typically employed when towing the windrower 1 along roads and highways. The second set of wheels comprises wheels 16, 17, 18 and 19. Wheels 16 through 19 are typically used when towing the windrower 1 using a second hitch assembly 20. The wheels 16 thorough 19 and the second hitch assembly 20 are typically employed when towing the windrower 1 across a farm field to perform a windrowing operation.

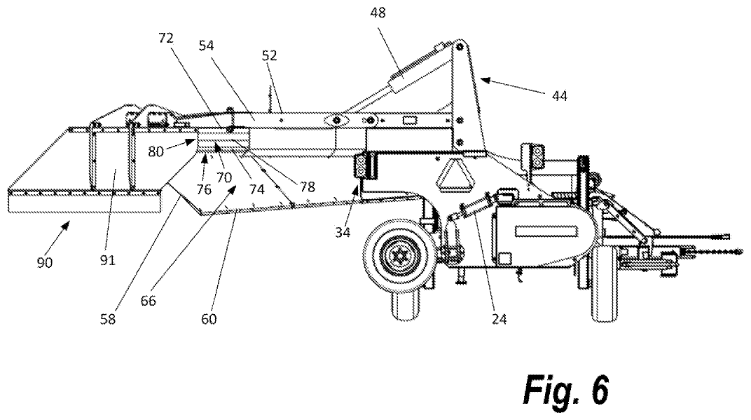

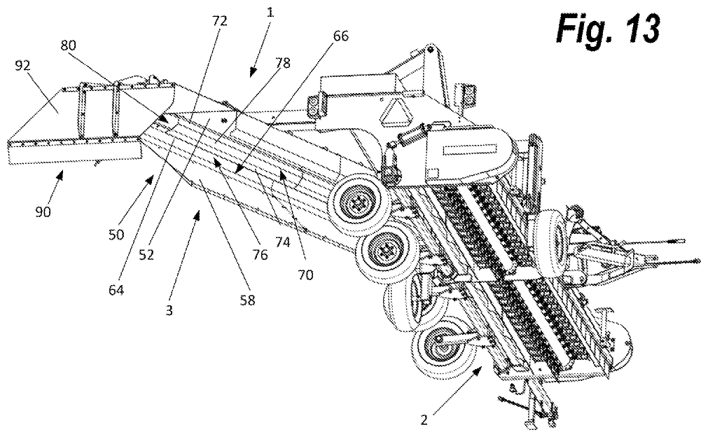

As illustrates, for example in FIG. 6, the wheels 16 through 19 are mounted relative to the frame 10 by tag axle linkages 22 that are each coupled to an axle 23 rotated by at least one linear hydraulic actuator 24 to move the wheels 16 through 19 between a retracted position shown in FIG. 6 and a deployed, ground engaging position shown in FIG. 13. When wheels 16 through 19 are in their deployed, ground engaging position, wheels 12 and 13 are lifted off the ground and the windrower is supported only by wheels 16 through 19. When wheels 16 through 19 are in their retracted position, the windrower 1 is supported by wheels 12 and 13 which are then in engagement with the ground.

The frame 10 supports a housing 26. Mounted within the housing are a plurality of rotary blade assemblies 28 each coupled to, and for rotation with, an axle 30 extending substantially the entire length of the frame. The shredder 2 also includes a power takeoff, gearbox and banded belt assembly which deliver rotational power to the axle 30 and rotary blade assemblies 28. Rotary speeds of the blade assemblies 28 range from about 1450 to 2000 revolutions per minute at about 280 horsepower.

Each rotary blade assembly 28 includes a plurality of blades 32. The blades 32 perform three functions as they are rotated. First, blades 32 pull and sever stover from the ground. Second, blades 32 process the stover into a fine particulate. Third, blades 32 create a first airflow into which the processed stover is entrained. This first airflow, and the processed stover entrained therein, is ejected from the housing through an elongate discharge opening 34 at the rear of the housing 26 and extending substantially along its entire length. Absent the presence of the wing 3, the airflow would scatter the processed stover in a randomized fashion behind the shredder 2 as it is pulled across the field by a tractor (not shown) coupled to the second hitch assembly and power takeoff.

One objective of the present invention is to prevent scattering of the processed stover and, instead, deposit the processed stover in a windrow adjacent a side of the windrower 1. This objective is met by employing a wing 3 constructed, and coupled to the frame 10 and housing 26, as discussed below.

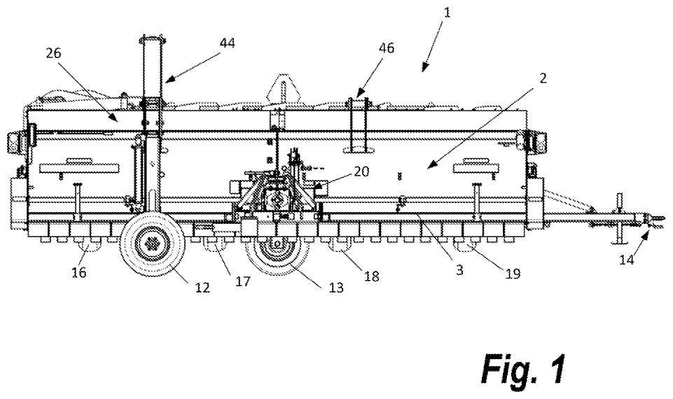

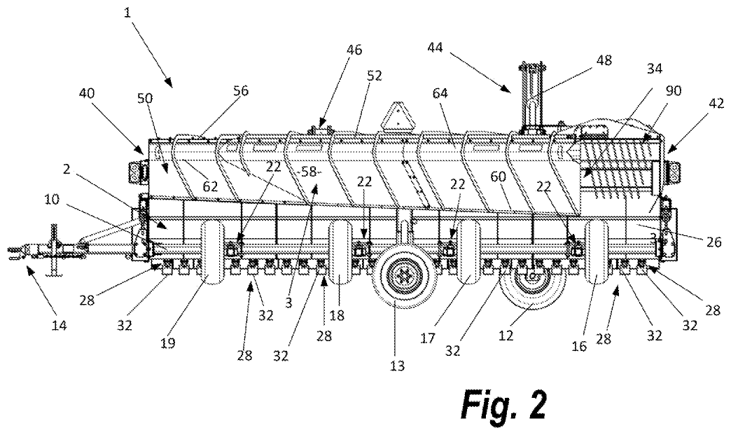

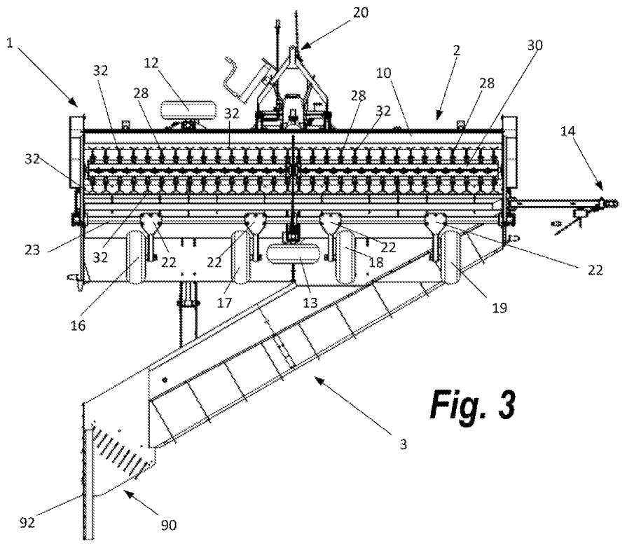

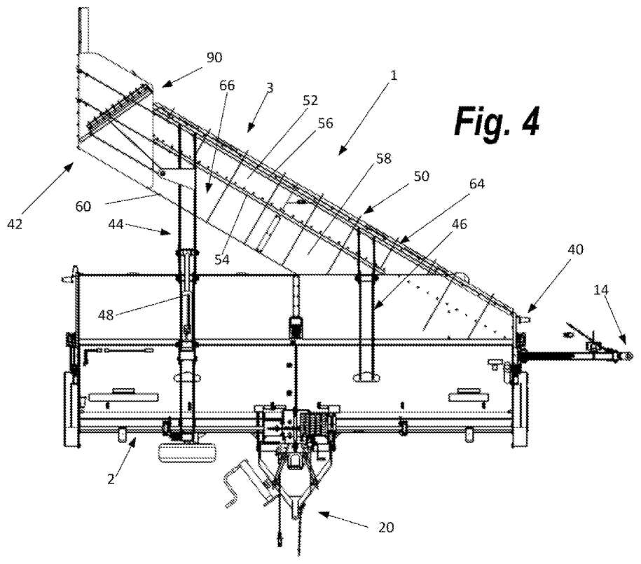

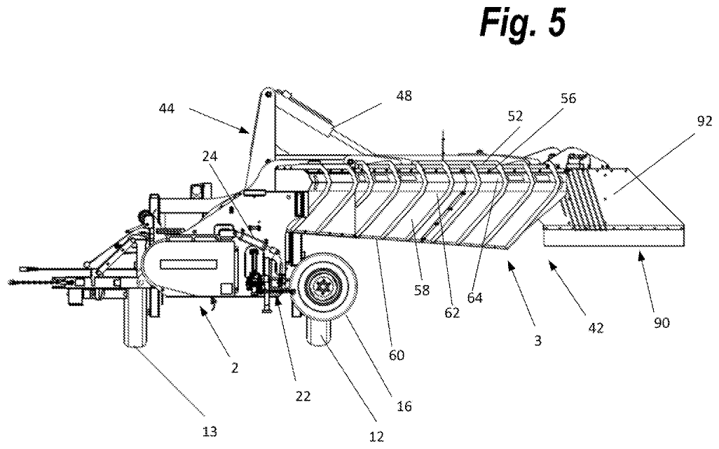

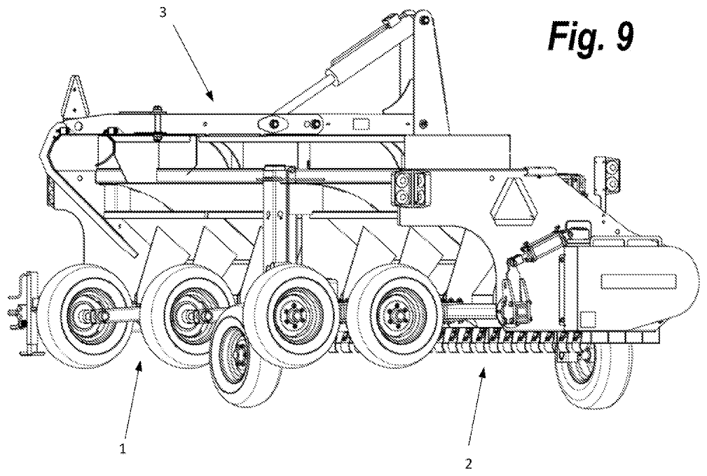

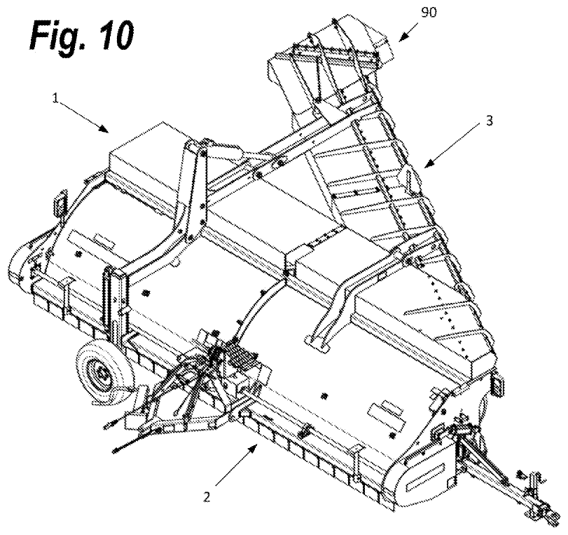

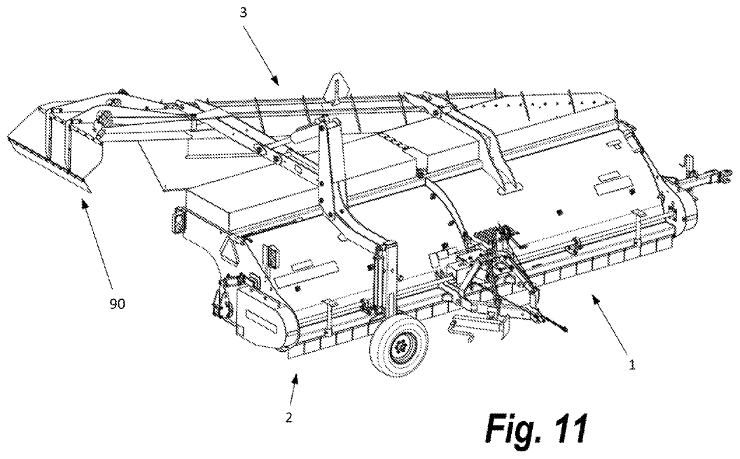

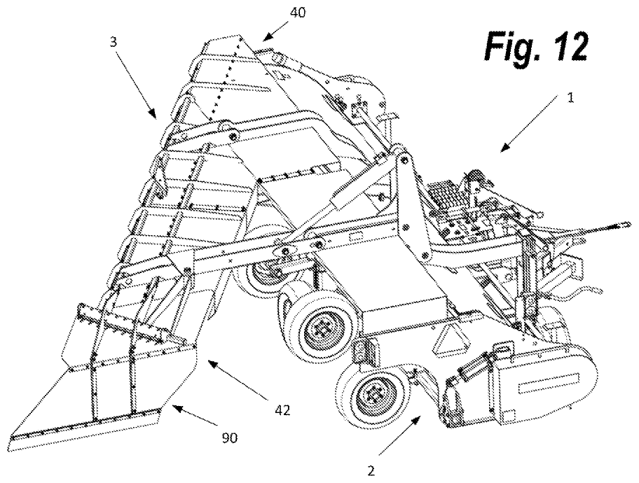

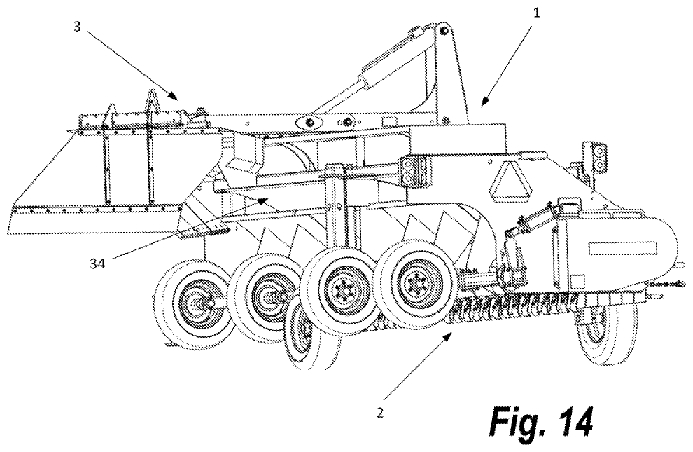

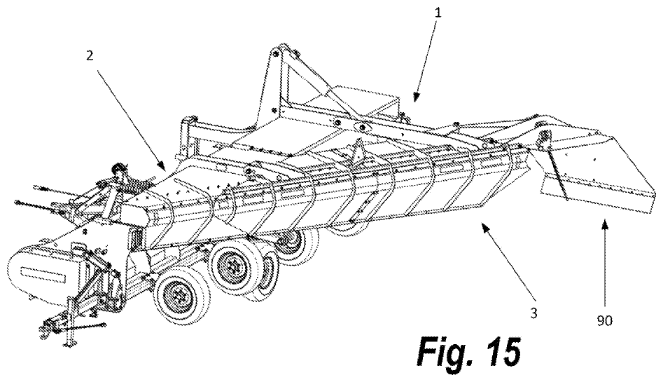

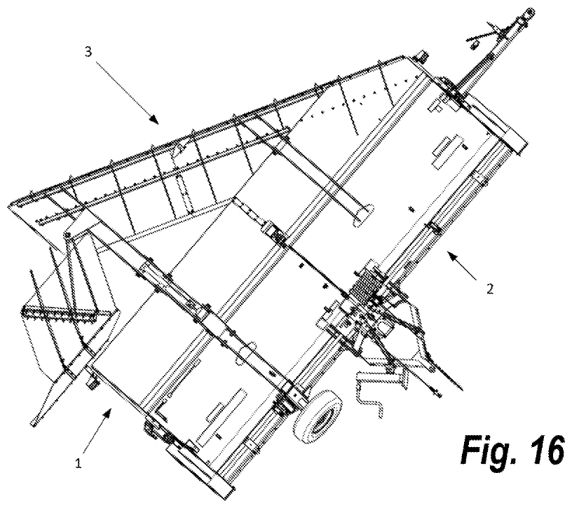

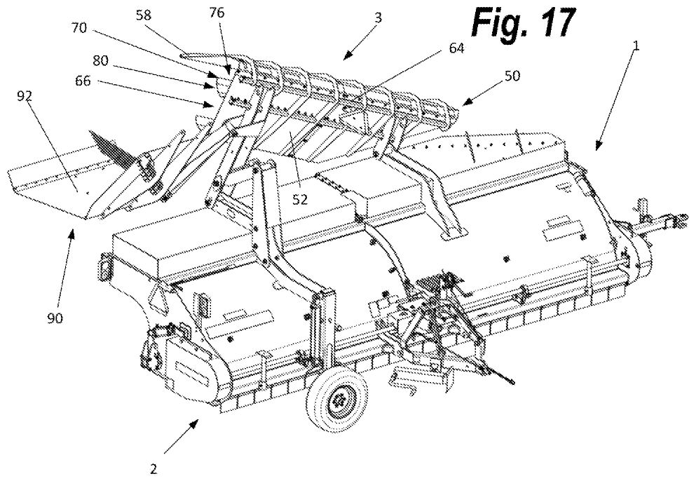

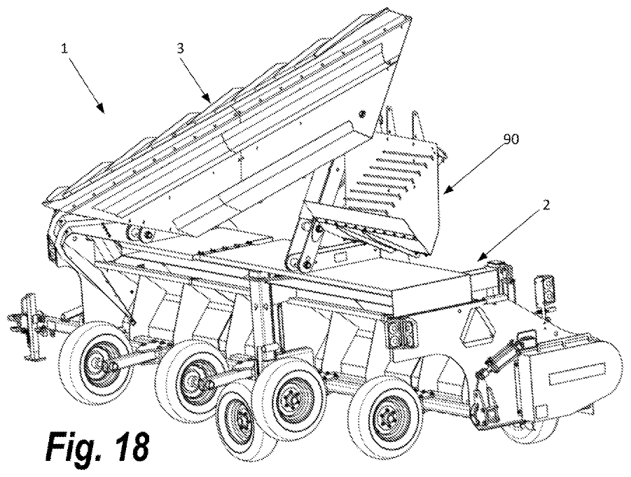

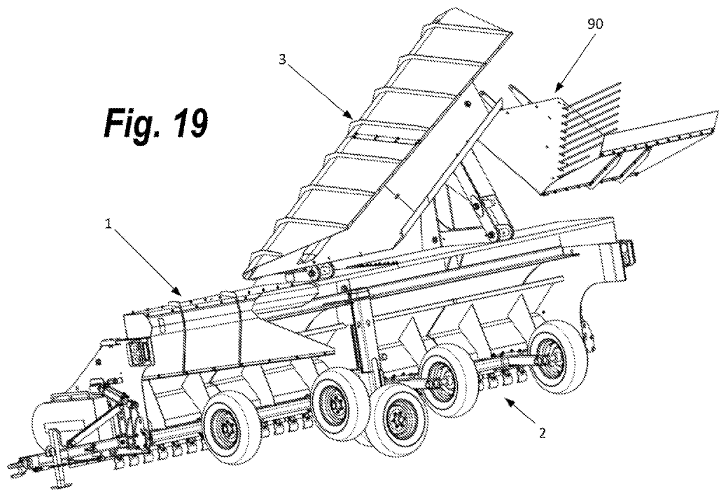

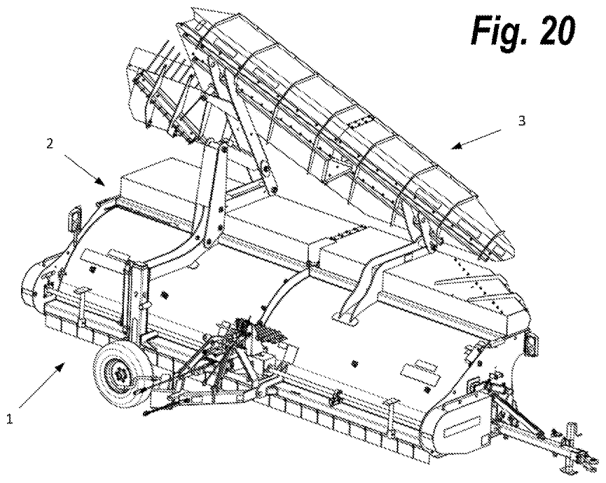

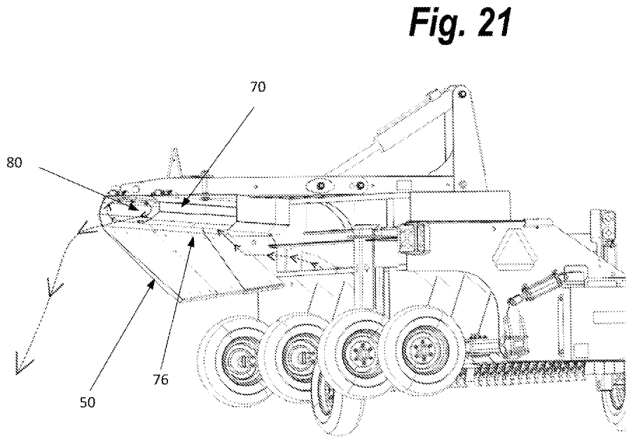

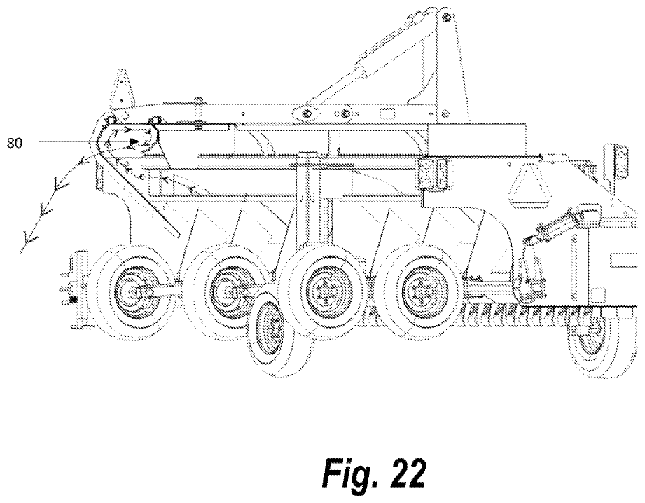

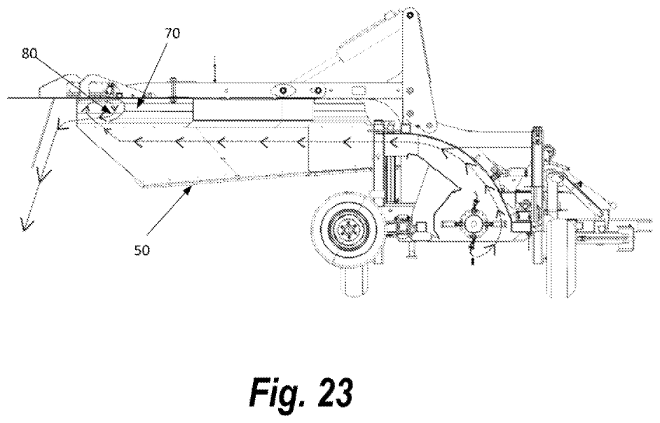

The wing 3 extends between a non-deposit end 40 and a deposit end 42. The wing 3 has a deployed position relative to the housing 26 shown in FIGS. 1 through 16 and 21 through 22. The wing 3 also has a stowed position illustrated in FIGS. 17 through 20. Then the windrower 1 is being used to process stover and organize the processed stover into rows, the wing 3 is in its deployed position. When the windrower is being readied for storage or transport via a road or highway, the wing 3 is moved to its stowed position. Moving the wing 3 between its deployed and stowed positions is facilitated by a first linkage 44 and a second linkage 46 coupling the wing 3 to the housing. A linear hydraulic actuator 48 coupled between two elements of linkage 46 is shown in several of the figures. Extending linear hydraulic actuator 48 moves the wing to the wing's deployed position which retraction of the linear hydraulic actuator 48 places the wing in the wing's stowed position. Other mechanisms, such as a ratchet assembly or lever, may be employed in conjunction with the first and second linkages 44 and 46 to move the wing 3 between the stowed and deployed positions. The linear hydraulic actuator or other such mechanism may be used to hold the wing 3 in either of its two positions. Separate locks, not shown, may also be employed to hold the wing 3 in either the wing's deployed or stowed position.

When the wing 3 is in its deployed position, the non-deposit end 40 of the wing sits closer to the housing 26, and the housing's elongate discharge opening 34, than the deposit end 42 of wing 3. In other words, the wing 3 is angled relative to the housing 26 and discharge opening 34. This angle causes processed stover ejected from the elongate discharge opening and engaging the wing to move along the wing toward the discharge end. The angle of the wing alone, however, is not enough to successfully deposit the processed stover in a windrow adjacent the windrower 1. The wing 3 is constructed with important design features that permit this to occur.

Specifically, the wing 3 has a primary baffle assembly 50 and a secondary baffle assembly 70. The primary baffle assembly 50 comprises a top plate 52 having a first proximal end 54 and a first distal end 56. The primary baffle assembly 50 further comprises a bottom plate 58 having a second proximal end 60 and a second distal end 62. A transition 64 extends between and couples the distal ends 56 and 62 so that the top plate 52 and the bottom plate are angled relative to each other creating a primary channel 66 facing the elongate discharge opening 34. As shown in various figures, the top plate 52 resides above the elongate discharge opening 34 and the bottom plate 58 extends below the bottom of the elongate discharge opening 34 when the wing 3 is in the deployed position. The primary channel may be closed at the non-deposit end 40 of the wing 3 but is open toward the elongate discharge opening 34 and at the deposit end 42 of the wing 3.

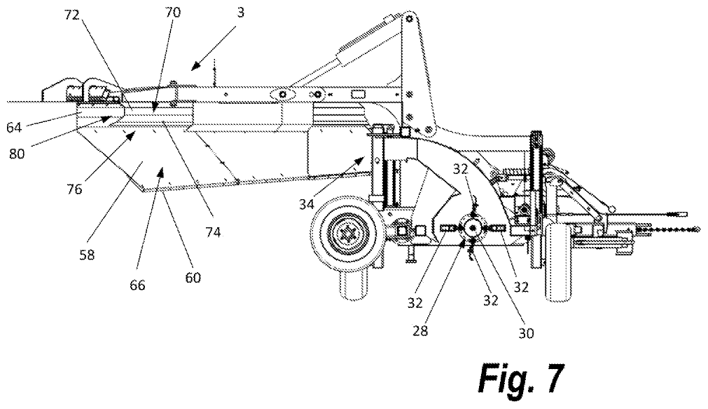

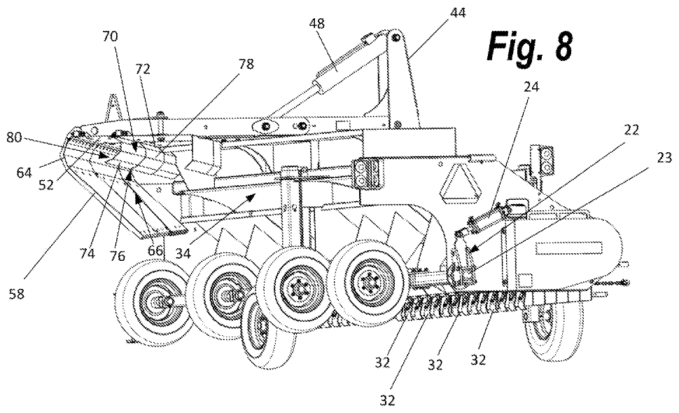

The secondary baffle assembly 70 resides in a top portion of the primary channel 66. As shown in FIGS. 7 and 8, the secondary baffle assembly 70 comprises a first wall portion 72 coupled to and descending from the top plate 52 and a second wall portion 74 extending toward the transition 64 and bottom plate 58 near where they meet. A space or gap 76 is left between the second wall portion and the transition 64 and bottom plate 58. The first wall portion 72 and second wall portion 74 are joined together by a second transition portion 78 which may be continuously curved or bent one or more times to provide an angular transition between the first wall portion 72 descending from the top plate 52 and second wall portion 74 extending away from the elongate discharge opening 34 toward the bottom plate 58 and transition 64. As so constructed, the primary baffle assembly 50 and secondary baffle assembly 70 cooperate to form a secondary channel 80 open along its length (see gap 76) and at the deposit end 42 of wing 3.

In some embodiments of the invention, the wing 3 may also include a tertiary baffle assembly 90 adjacent the open ends of the primary channel 66 and secondary channel 80 at the deposit end 42 of the wing 3. The tertiary baffle assembly 90 operates to deflect to the ground the processed stover exiting the primary channel 66 and secondary channel 80 through their open ends at the deposit end 42 of the wing 3. The tertiary baffle assembly may comprise a single descending panel 92 or a plurality of such panels or rods. Employing rods or a plurality of panels allows air to pass through as the stover is directed to the ground.

When the windrower 1 is in use, the wing 3 is placed in its deployed position and the windrower 1 is hitched to a tractor and the power takeoff is mechanically coupled to the tractor's engine and engaged causing the rotary blade assemblies 28 to spin. As the tractor pulls the windrower 1 through a farm field, the blades 32 pull the stover left in the field into the housing 26, cut the stover into particles (i.e., processed stover) and create a first airflow in which the processed stover becomes entrained. This first airflow and the entrained processed stover exits the housing 26 through the elongate discharge opening 34 and then is caught by the wing 3. The wing 3 divides the first airflow into two distinct second and third airflows, specifically a second airflow created in the primary channel and a third airflow created in the secondary channel.

The shape of the primary baffle assembly 50 redirects the first airflow such that some of this airflow is directed along the primary channel 66 toward the deposit end 42 of the wing 3 and a substantial portion (most) of this airflow is directed into the secondary channel 80 through the gap 76. The secondary baffle assembly 70 causes the air entering the secondary channel 80 to flow both in a rotational and longitudinal screw-like fashion toward and out the deposit end 42 of the wing 72. The continuous influx of air through the gap acts as an air curtain. When a tertiary baffle assembly 90 is employed, processed stover exiting through the open ends of the primary channel 66 and secondary channel 80 at the deposit end 42 of the wing 3 is deflected to the ground by the tertiary baffle assembly 90 to form a windrow.

When the windrower 1 is not in use or needs to be transported over a public roadway, the wing 3 is be moved to its stowed position shown in FIGS. 17 through 20. Additionally, the tractor is moved from hitch assembly 20 to hitch assembly 14, and the tag axle linkages 22 are operated by the linear hydraulic actuator 24 to retract the second set of wheels 16-19 so that the windrower 1 is supported by the wheels 12 and 13.

Various additional advantages of the present invention should be apparent to one of ordinary skill in the art from the foregoing detailed description and the accompanying drawings. This disclosure is therefore not intended to be limiting.

1. A windrower comprising:
a. a shredder having a housing surrounding a plurality of spinning knives adapted to process stover and discharge processed stover via a first airflow through an elongate discharge opening in the housing; and
b. a wing having
i. a non-deposit end,
ii. a deposit end,
iii. a first baffle assembly forming a primary channel, said primary channel having a top portion and extending the length of the wing between the non-deposit end and a deposit end and open toward elongate discharge opening and the deposit end,
wherein the non-deposit end of the wing is positioned closer to the housing than the deposit end of the wing, and wherein said primary channel of the wing is adapted to receive the first airflow and processed stover and redirect the first airflow and processed stover through said primary channel and out the deposit end of the wing.

2. The windrower of claim 1 wherein said wing further comprises a second baffle assembly adapted to direct toward the ground processed stover exiting said first channel at the deposit end of the wing.

3. The windrower of claim 1 wherein said first baffle assembly comprises a top plate having a first proximal end and a first distal end, a bottom plate having a second proximal end and a second distal end and a transition extending between the first distal and second distal end, wherein the bottom plate is dimensionally wider than the top plate.

4. The windrower of claim 1 wherein said wing further comprises a subassembly positioned within the top portion of the primary channel and adapted to form a secondary channel, said secondary channel extending the length of said wing between the non-deposit end and the deposit end and open toward a portion of the primary channel and the deposit end, wherein said subassembly is spaced from the transition and bottom plate creating a gap and comprises a first wall portion extending from the top plate and a second wall portion extending toward the transition.

5. The windrower of claim 3 wherein the top plate is positioned above the top of the discharge opening.

6. The windrower of claim 4 wherein said gap is above the discharge opening.

7. The windrower of claim 4 wherein said subassembly is configured to cause a portion of the first airflow and any of the stover entrained in said portion to enter the second channel and cause said portion of the first airflow and any of the stover entrained in said portion to move in a longitudinal and rotational manner toward the deposit end of the wing.

8. The windrower of claim 1 wherein said wing is configured relative to the shredder between a stowed position wherein the wing is above the housing and a deployed position in which the wing is behind the housing.

9. The windrower of claim 1 further comprising a pair of linkages and at least one actuator configured to rotate the wing relative to the shredder between a stowed position wherein the wing is above the housing and a deployed position wherein the wing is behind the housing.

10. The windrower of claim 4 wherein the wing is configured to cause the first airflow to be divided into a second airflow and a third airflow, said second airflow directed by said primary channel to and out the deposit end of the wing and said third airflow directed by said secondary channel to and out the deposit end of the wing.

11. A wing for a windrow machine, said wing comprising:
a. a non-deposit end,
b. a deposit end,
c. a primary baffle assembly forming a primary channel, said primary channel extending the length of the wing between the non-deposit end and a deposit end and open toward the deposit end, and
d. a secondary baffle assembly positioned within the primary channel and cooperating with the primary baffle assembly to form a secondary channel, said secondary channel extending the length of the wing between the non-deposit end and a deposit end and open toward a portion of the primary channel and the deposit end,
wherein the wing is adapted to be attached to a shredder having a housing surrounding a plurality of spinning knives adapted to process stover and discharge processed stover via a first airflow through an elongate discharge opening in the housing, wherein said non-deposit end of the wing is positioned closer to the housing than the deposit end of the wing, and wherein primary and secondary-channels of the wing are adapted to receive the first airflow and processed stover and redirect the first airflow and processed stover through the primary channel and secondary channel toward and out the deposit end of the wing.

12. The wing of claim 11 further comprising a tertiary baffle assembly at the deposit end of the wing, said tertiary baffle assembly adapted to direct toward the ground processed stover exiting the primary and secondary channels at the deposit end of the wing.

13. The wing of claim 11 wherein said primary baffle assembly comprises a top plate having a first proximal end and a first distal end, a bottom plate having a second proximal end and a second distal end and a transition extending between the first distal end and second distal end, wherein the bottom plate is dimensionally wider than the top plate.

14. The wing of claim 13 wherein said secondary baffle assembly comprises (i) a front portion descending from the top plate, and (ii) a bottom portion extending from the from portion toward at least one of the bottom plate and transition, and (iii) a gap between the bottom portion and said at least one of the bottom plate and transition.

15. The wing of claim 13 wherein the top plate is positioned above the top of the discharge opening.

16. The wing of claim 14 wherein said gap is positioned above the discharge opening.

17. The wing of claim 11 wherein said front portion and said bottom portion of the second baffle assembly form a continuous curve.

18. The wing of claim 11 wherein said wing is configured to rotate relative to the shredder between a stowed position wherein the wing is above the housing and a deployed position in which the wing is behind the housing.

19. The wing of claim 11 further comprising a pair of linkages and at least one actuator configured to rotate the wing relative to the shredder between a stowed position wherein the wing is above the housing and a deployed position wherein the wing is behind the housing.

20. The windrower of claim 11 wherein the wing is configured to cause the first airflow to be divided into a second airflow and a third airflow, said second airflow directed by said primary channel to and out the deposit end of the wing and said third airflow directed by said secondary channel to and out the deposit end of the wing.
